(19) United States
(12) Patent Application Publication
(10) Pub. No.: US 2012/0206601 A1
(43) Pub. Date: Aug. 16, 2012

(54) DISTORTION CORRECTION OF VIDEO SYSTEMS

(76) Inventors: Ulrich Seger, Leonberg-Warmbronn (DE); Gerald Franz, Backnang (DE)

(21) Appl. No.: 13/382,870

(22) PCT Filed: Jun. 23, 2010
(86) PCT No.: PCT/EP2010/058865

§ 371 Date: Apr. 24, 2012

(30) Foreign Application Priority Data
Jul. 8, 2009 (DE) 10 2009 027 520.7

(51) Int. Cl. H04N 7/18

(52) U.S. Cl. 348/148; 348/E07.085

(57) ABSTRACT

In a method for distortion-free acquisition of image data through a windshield, the image recording system acquires the recording area through a transparent rectifying pane which has a shape deviation relative to the windshield and is positioned in the interior of the motor vehicle. Furthermore, an image correction device has a mounting device, which is configured to be indirectly or directly fastened on a windshield in the interior of a motor vehicle, and a transparent rectifying pane, which is fastened on the mounting device. The mounting device positions the rectifying pane having a shape deviation relative to the windshield in the interior of the motor vehicle.

### BACKGROUND OF THE INVENTION

1. Field of the Invention

The present invention relates to a method and a system for distortion correction of video systems.

2. Description of Related Art

Motor-vehicle-supported video systems, for example, front view video systems, acquire a recording area located in front of the vehicle via optical means. The image is acquired through a window pane in this case, which terminates the passenger compartment of the vehicle.

In particular in the case of front view video systems, the recording area located in front of the vehicle is acquired through the windshield of the motor vehicle. The positioning of the optical system required for the acquisition in a position behind the windshield is necessary in order to protect the optical system and in particular the camera from soiling or damage, which are caused by spray water or the like during travel. Furthermore, the optical system and in particular the camera are positioned inside the passenger compartment in order to also protect them from further direct environmental influences (weathering), when the motor vehicle is not parked in enclosed spaces.

However, the camera image experiences an optical distortion due to the windshield, essentially along one direction, compared to an image without a windshield. This distortion results due to the beam path through the windshield, and in particular due to different courses of the beam path as a function of the angle of the beam path with respect to the curve of the windshield. In particular, distortions result in the case of recording areas which cover a broad angle range, i.e., an angle range having beam paths which are incident on the windshield both at an acute angle and also at a nearly perpendicular angle. Such distortions therefore occur if both pavement and traffic lights or other elevated traffic signs are to be detected in the same image area, for example.

Such distortions are compensated for in systems according to the related art using image processing algorithms, which are implemented using a high computing effort in a data processing system, using which an acquired image is electronically processed further.

While windshields generate an essentially linear distortion along one direction (i.e., in the direction of the azimuth angle), more complex distortions result in the case of more complex shapes. Because of the calculation complexity, which thus increases strongly, image processing algorithms have only limited suitability for compensation for complex distortion geometries.

Published German utility model application document DE 3880075 T2 provides a device for the compensation of achromatization, which results due to the curvature of aerodynamically shaped cockpit window panes of aircraft. A complex required optical imaging for the optical compensation mechanism, which includes two deflection prisms, in order to cause an anamorphosis in the azimuth direction by changing the focal width in combination with deflection and anamorphosis in the elevation direction, results from the complex curvature of the cockpit window panes. On the one hand, the device described therein is provided for rectifying distortions through conical glass surfaces, which fundamentally differ from distortions of windshields (e.g., with respect to the complexity), and, on the other hand, the device proposed therein is composed of multiple complex elements to be adapted to one another and to be adjusted precisely to one another, which have specific material properties. However, it is to be noted in particular that published German utility model application document DE 3880075 T2 is not capable of compensating for longitudinal distortions as occur in windshields.

### BRIEF SUMMARY OF THE INVENTION

The present invention is based on the concept of at least partially compensating for a stretching in one direction, as occurs upon the passage of a beam path through a windshield inclined thereto, using a rectifying pane, which has a shape deviation relative to the windshield with respect to a plane-parallel plate which is parallel to the windshield. This shape deviation is provided either by (i) a curvature of the rectifying pane, which is essentially complementary to the curvature of the windshield, (ii) a non-plane-parallel or wedge-shaped design of the rectifying pane, (iii) by positioning the rectifying pane at an angle to the windshield, or by an arbitrary combination of these features, i.e., by the combination (i) and (ii) and (iii), by the combination (i) and (ii), by the combination (ii) and (iii), or by the combination (i) and (iii).

A shape deviation is understood to be a curvature which does not correspond to the curvature of the windshield, a non-plane-parallel design of the windshield, i.e., design of the windshield having a non-constant thickness, and an angled position of the rectifying pane relative to the windshield. According to the last-mentioned feature, the shape deviation described here therefore also includes a deviation in the orientation with respect to the windshield.

The curvature of the rectifying pane, which is essentially complementary to the curvature of the windshield, may be implemented by a shape running along a spatial angle section of a ring, in particular by a toroidal curvature or, in a simplified specific embodiment, by a cylindrical curvature. This curvature only relates to a small angle section of a torus or cylinder and not a shape which corresponds to a full torus or cylinder. The curvature of the rectifying pane is provided by a corresponding curvature of at least one outer side of the rectifying pane. Both outer sides of the rectifying pane may have the desired complementary curvature, or only one outer side of the rectifying pane may have the desired complementary curvature, the opposing outer side running along a plane, for example.

The non-plane-parallel (i.e., the curve of the rectifying pane which tapers monotonously, strictly monotonously, or with constant thickness reduction) or wedge-shaped design of the rectifying pane includes a curve of the rectifying pane in which the two outer surfaces of the pane taper toward a point, or toward a straight line, or toward a line whose length is only a part of an outer edge of the rectifying pane. Both the straight line and also the point may lie inside the rectifying pane, preferably on a boundary or an outer edge of the rectifying pane, or may lie at one point in an extension of the rectifying pane. According to one approach, the non-plane-parallel or wedge-shaped design is provided by a non-constant thickness of the rectifying pane, which decreases monotonously, strictly monotonously, or constantly to a point, to a straight line, or to a line (as described above).

The non-plane-parallel wedge-shaped design of the rectifying pane is provided, for example, by pressing a transparent plastic plate (which is plane-parallel in particular), in particular by blank pressing of a plastic correction plate, which provides the rectifying pane with the desired shape after pressing.

The positioning of the rectifying pane at an angle to the windshield relates to an angle between the outer surface of the rectifying pane, which faces toward the windshield, the angled position provided by this angle being described in greater detail during the course of the description.

Instead of or in combination with optical measures (i), (ii), and/or (iii), the index of refraction of the rectifying pane may also have a non-constant curve. This is achieved, for example, by corresponding anisotropy of the composition or physical properties (for example, inhomogeneous density distribution through inhomogeneous pressing of a homogeneous plastic plate). This may also be referred to as shape deviation according to the present invention, although the plate itself does not necessarily have a material, physical shape deviation in its external dimensions, but rather is equivalent in its optical properties to a material shape deviation. The term material, physical shape deviation relates to the curve of the outer surfaces of the pane. According to the present invention, an optical behavior for beams passing through the pane, which deviates from an optical behavior of a plane-parallel plate having a constant index of refraction, is (generally) referred to as a shape deviation.

All of these measures are designed to at least partially compensate for the distortion which is caused by the windshield.

As a further preferred specific embodiment, the method according to the present invention and the image correction device according to the present invention are provided by only a single rectifying pane. In this specific embodiment, the rectifying pane according to the present invention is the single optical element (i.e., element which modifies the optical beam path), which is provided between the image recording device (and its lens) and the windshield. The image recording device may be provided as a typical camera, which does not have any further optical rectification or distortion elements and only includes a lens system (having at least one lens) provided for undistorted image recording, the rectification of the distortion provided by the windscreen essentially only being provided by the single (preferably single-layer) rectifying pane. Only the single rectifying pane provides the rectification.

Since the beam path is guided through both the windshield and also the transparent rectifying pane, the respective effects are combined with one another, the effect of the rectifying pane being essentially complementary to the effect of the windshield. While the windshield only slightly distorts the beam paths incident on the windshield from the front, i.e,, in the case of the angled position of the rectifying pane at an acute angle, significantly stronger distortions, in the form of stretching which increases with the angle to the windshield, result upon passage of beam paths at an essentially perpendicular angle. Since the respective beam paths run through the entire thickness of the rectifying pane (at various angles to the rectifying pane surface), the stretching generated by the windshield is compensated for by an appropriate compression. Since the stretching is a function of the angle of the beam path, the compensation, i.e., the compression, is also a function of the angle of the beam path, but inversely.

In addition to a particularly simple construction, which may be implemented very cost-effectively and occupies little space, the present invention allows adaptation to various windshield geometries (i.e., in particular angle of inclination and windshield thickness) by simple adjustment of the angle between the rectifying pane and the windshield. Furthermore, the rectifying pane may be adapted easily to properties of the windshield, to compensate for the distortion caused by the windshield, by suitable selection of thicknesses of the rectifying pane, the material properties, in particular the index of refraction of the rectifying pane, and optionally the shape or the curvature of the rectifying pane.

According to the present invention, for rectification when acquiring image data through a windshield, an image recording system is therefore provided in the interior of a motor vehicle, and the optical axis of the image recording system is oriented to a recording area outside the motor vehicle. Image data of the external recording area are acquired through the windshield, which is inclined to the optical axis. To compensate for distortions which are thus generated, during the acquisition of the image data, the recording area is acquired through a transparent rectifying pane. The transparent rectifying pane is positioned angled or inclined to the windshield in the interior of the vehicle during the acquisition, or is positioned curved (essentially complementarily to the curvature of the windshield), or is positioned as a non-plane-parallel or wedge-shaped design of the rectifying pane, the two outer surfaces of the rectifying pane having different angles to the windshield due to the positioning. These measures may be combined as described above.

The index of refraction of the rectifying pane may differ from the index of refraction of the material from which the windshield is manufactured. Through the selection of the index of refraction (or its curve), by which the beam path within the rectifying pane is manipulated, the rectifying pane may be adapted for compensation to the windshield and its optical properties. In this case, the image is preferably recorded through a PMMA plate, which provides the rectifying pane.

According to a further preferred specific embodiment, the image data are acquired through a plate (which is plane-parallel, for example), which forms the rectifying pane. The angle between the rectifying pane and the windshield, i.e., the inclination between the windshield and the plane-parallel plate which provides the rectifying pane, is preferably provided by the inclination of the plane-parallel plate to the windshield in a plane in which the optical axis lies. The rectifying pane is preferably inclined at an azimuth angle to the windshield. The angle between the windshield and the rectifying pane is preferably <15°, <10°, <8°, <5°, <2°, or even <1°, but preferably >0.1°, >0.2°, or >0.5°.

The windshield is preferably inclined at a positive acute angle to the optical axis. The optical axis runs essentially horizontally, while in contrast the windshield is raised upward toward the end of the vehicle. In this system, the rectifying pane through which the image data are acquired is also inclined at a positive acute angle to the windshield. The sign of the angle is a function of the viewing direction, so that according to an alternative mode of viewing, the windshield is inclined at a negative acute angle to the optical axis, and the rectifying pane is inclined at an acute angle to the windshield which has the same sign, i.e., is negative.

The transparent rectifying pane provides a compression of the image in one direction, the windshield being inclined to the optical axis in this direction. Since the inclination or curvature or wedge-shaped design of the windshield to the optical axis generates stretching which is complementary to the compression in one direction, i.e., in the direction of the azimuth angle, a compression is provided in this direction by the rectifying pane. The compression is provided using a degree of compression which decreases in this direction, i.e., in the direction of the azimuth angle, with an increasing angle to the windshield. The flatter a beam path runs to the windshield, the less the compression which is generated by the rectifying pane. The degree of compression increases the more a light beam is inclined to the perpendicular of the windshield (and also to the perpendicular of the rectifying pane), since the stretching provided by the windshield increases in the azimuth direction with the angle, i.e., rises with increasing proximity to the perpendicular. Fundamentally, the stretching which a beam path experiences upon incidence on the windshield in the perpendicular may also be viewed as a normalization point for an undistorted transmission, the windshield providing an increasing compression with an increasing angle to the perpendicular. However, when viewing in this way, the same variation of the degree of compression which is provided by the rectifying pane results. As a function of the normalization point, however, the compression provided by the rectifying pane may also be viewed in its inverse property, i.e., as stretching by the rectifying pane.

An image correction device according to the present invention includes a mounting device, which is fastened with respect to the windshield, either by an indirect or a direct fastening. A mounting device is configured, like the rectifying pane, in the interior of the motor vehicle, in particular in the passenger compartment. A transparent rectifying pane according to the present invention is connected to the mounting device. The rectifying pane has therefore a constant spatial relation with respect to the windshield due to the mounting device (and optionally additional fastening). In particular the angle between the rectifying pane and the windshield or the variation of the curvature or the variation of the tapering of the rectifying pane is fixed by the mounting device and the fastening. Because of the angle according to the present invention between the rectifying pane and the windshield or because of the variation of the curvature or the variation of the tapering of the rectifying pane, the mounting device is designed in such a way that it positions the rectifying pane via the fastening at an angle inclined to the windshield or provides the variation of the curvature or the variation of the tapering with respect to the windshield. The rectifying pane is thus in particular positioned in the interior of the motor vehicle having a fixed spatial relation to the windshield.

The index of refraction of the rectifying pane which is held by the mounting device preferably differs from the index of refraction of the windshield; a spatial distribution of the index of refraction in the rectifying pane may also differ from a distribution of the index of refraction in the windshield. The optical effect of the rectifying pane may be provided complementarily to the optical effect of the windshield, in particular in consideration of the angle between the rectifying pane and the windshield, through these different indices of refraction or their distributions.

The rectifying pane is preferably designed as a plate, and as plane-parallel according to a specific embodiment. The rectifying pane therefore includes two surfaces which run along two planes (which are parallel to one another) or along two curved surfaces. However, the rectifying pane provided as a plate may optionally also have a curvature in the azimuth direction, in order to optionally allow additional optical properties to compensate for the distortion provided by the windshield. As already described, the rectifying pane is preferably manufactured from a plastic material, for example, from PMMA; the rectifying pane may also be manufactured from other materials, however, for example, from glass, which differs from the material from which the windshield is manufactured. The rectifying pane preferably has the same thickness as the windshield, but may also have a lesser or a greater thickness than the windshield, in order to thus be able to compensate for the distortion caused by the windshield.

The windshield is inclined at a positive acute angle to a longitudinal axis of the motor vehicle, along which the optical axis runs, or has a compensating variation of the curvature or variation of the tapering with respect to the windshield, due to the mounting device of the image correction device. The rectifying pane is inclined at a positive acute angle to the windshield according to a specific embodiment, the same viewing system being used in this case as when considering the angle between the windshield and the longitudinal axis. As already noted, in an alternative viewing system, both angles may have a negative sign; however, both angles may be acute angles, on the one hand, and have the same sign, on the other hand, independently of the viewing system.

Furthermore, the present invention is implemented by an image recording system which includes an image correction device according to the present invention. The image recording system is configured to be positioned in the interior of the motor vehicle and includes a camera device. The image correction device is positioned between the camera device and the windshield in an optical axis of the image recording device and the camera device in front of the camera device. The camera device is therefore oriented toward the image correction device and simultaneously also oriented toward a recording area outside the motor vehicle. The camera device is therefore oriented as a whole through the image correction device and through the windshield toward a recording area outside the motor vehicle, in particular, the mounting and its fastening relative to the windshield providing this orientation of the camera device. In this system, the rectifying pane is preferably the only element through which the beam path runs between the camera device and the windshield.

### BRIEF DESCRIPTION OF THE DRAWINGS

FIG. 1 shows a device according to the present invention in a symbolic view to explain the method according to the present invention.

FIGS. 2a and 2b show a distortion error in uncompensated optical systems (FIG. 2a) and after the correction according to the present invention (FIG. 2b).

### DETAILED DESCRIPTION OF THE INVENTION

The figures relate to a specific design of the present invention, in which the rectifying pane is positioned inclined to the windshield.

Further embodiments of the present invention (not shown) provide a variation of the curvature at least in one extension direction of the windshield complementary to the windshield, or a variation of the tapering which at least partially compensates for the distortion by the windshield in at least one extension direction of the windshield.

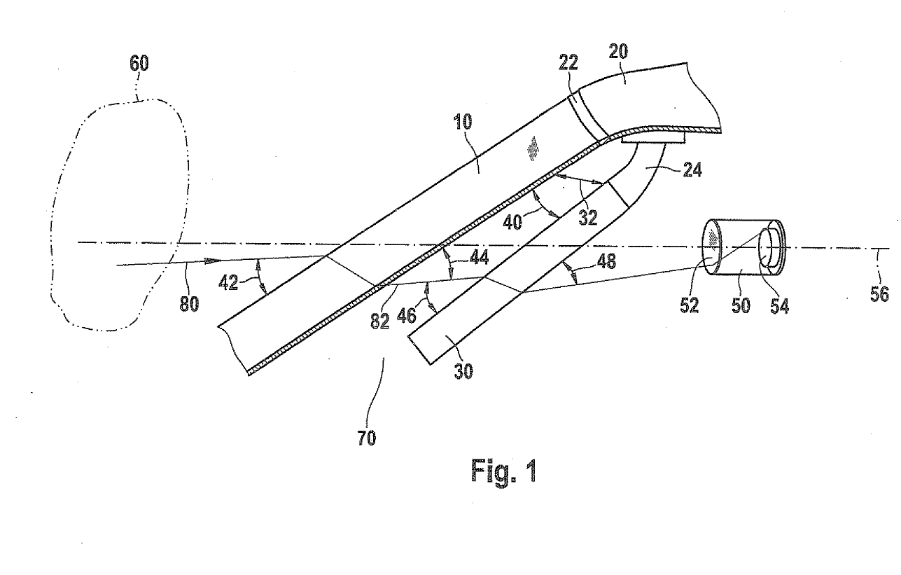

FIG. 1 shows a windshield 10 and an adjoining roof 20 of a motor vehicle, which holds windshield 10 via a mounting 22, in cross section. A further mounting 24 (shown symbolically) is provided on the roof, using which a rectifying pane 30 according to the present invention is fastened to the roof and therefore indirectly to windshield 10. Rectifying pane 30 is therefore in a fixed spatial relationship to windshield 10. A spacing 32 between windshield 10 and rectifying pane 30 is only used for the exemplary illustration and may be reduced to zero. Furthermore, it is to be noted that the rectifying pane and the windshield are positioned at an acute angle 40 to one another.

The system shown in FIG. 1 further includes an image recording system 50 having an imaging lens 52 and an image recording sensor 54. These define optical axis 56 of the entire optical system. Camera device 50 is oriented through rectifying pane 30 and windshield 10 toward a recording area 60. Recording area 60 is in front of the windshield and outside passenger compartment 70, which is located behind the windshield.

A light beam 80 originating from recording area 60 is incident on windshield 10 at a first angle 42 and is refracted due to the index of refraction of windshield 10 on the windshield surface and diffracted toward windshield 10. The more perpendicularly beam 80 is incident on the windshield, i.e., the more angle 42 corresponds to a 90° angle, the greater the angle difference between the beam incident on the windshield and beam 82 exiting from the windshield. Therefore, an angle difference results between the absolute values of angles 42 and 44 which is a function of the angle of incidence of beam 80. Reference numeral 44 is the angle which beam 82 exiting from the windshield forms with windshield 10. If the angle differences were not a function of the entry angle of beam 80 to windshield 10, the distortion provided by the windshield could be compensated for by a constant, angle-independent compression, for example, by appropriate adaptation of optics 52, 54. However, since the angle difference is greater the steeper angle 80 is incident on windshield 10, angle-dependent stretching (or also compression, as a function of the starting point) is provided by the windshield, which must also be compensated for by rectifying pane 30 as a function of the angle. Through corresponding inclination of rectifying pane 30 to the windshield, an effect complementary thereto results, entry angle 46 of beam 82 on rectifying pane 30 resulting in a corresponding refraction on rectifying pane 30 (because of their properties, in particular because of the refraction properties), and exit angle 48 is compensated for by the distortion by the windshield. The compensation occurs in that a nearly perpendicular angle of incidence on the windshield (strong angle difference) is converted into a significantly flatter beam which is incident on rectifying pane 30, the entry angles on the rectifying pane and on the windshield of the same beam path causing angle differences in each case to their associated exit angles which are complementary to one another. The desired inverse angle dependence thus results, using which the distortion effects of the windshield may be compensated for by the rectification effects of the rectifying pane.

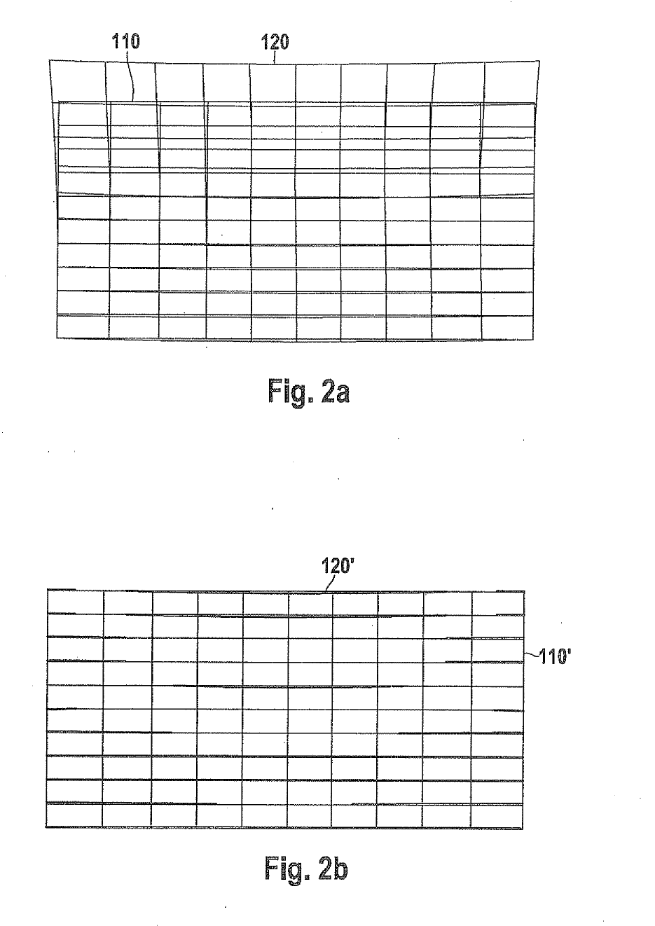

FIG. 2a shows two lattices lying one over another, first, regular, and undistorted lattice 110 representing a normal lattice, which induces a normal exit beam path in the recording area (compare reference numeral 60 of FIG. 1). The axis extending to the right in FIG. 2a corresponds to a direction which runs perpendicularly into the plane of the drawing in FIG. 1, the axis leading upward in FIG. 2a corresponding to an azimuth angle, i.e., in FIG. 1, the axis leading upward in the plane of the drawing. The lattice identified by reference numeral 120 corresponds to normal lattice 110 after passage through the windshield (in FIG. 1: reference numeral 10). It may be seen that in the lower areas, i.e., at very flat angles of incidence (compare reference numeral 42 of FIG. 1), only slight distortions result, the distortion growing significantly the closer the entry angle approximates the perpendicular to the windshield. In particular, it may be seen that the uppermost row is stretched by a factor of nearly two in the azimuth direction, i.e., in FIG. 2a in the Y direction.

As already explained on the basis of FIG. 1, this angle-dependent distortion is canceled out by the complementary effect of the rectifying pane, which provides a compression for strongly perpendicularly incident beam paths, which is less in the case of more flatly incident beam paths. FIG. 2b therefore shows normal pattern 110′ (already shown in FIG. 2a), and associated image 120′, which was distorted by the windshield and rectified by the rectifying pane. It may be seen from a comparison between FIG. 2b and FIG. 2a that the distortion provided by the windshield may be nearly completely compensated for by the rectification according to the present invention, so that pattern 120′ acquired by the camera system is nearly identical to originally emitted normal pattern 110′.

Furthermore, it may be seen from the comparison between FIGS. 2a and 2b that an additional horizontal pincushion distortion in FIG. 2a is noticeable in particular in the upper rows, which may be compensated for by suitable curvature of the rectifying pane. The suitable curvature essentially corresponds to the curvature of the windshield in this area. Preferably, the surface of the rectifying pane facing toward the windshield runs equidistantly to the surface of the windshield facing toward the rectifying pane. The opposing surface of the rectifying pane runs equidistantly to the surface of the rectifying pane which faces toward the windshield.

1-11. (canceled)

12. A method for distortion-free acquisition of image data through a windshield of a motor vehicle, comprising:
providing an image recording system in the interior of the motor vehicle;
orienting the image recording system along an optical axis of the image recording system toward a selected recording area outside the motor vehicle; and
acquiring image data of the recording area through the windshield and through a transparent rectifying pane positioned in the interior of the motor vehicle, wherein the windshield is inclined relative to the optical axis, and wherein the transparent rectifying pane has a shape deviation relative to the windshield.

13. The method as recited in claim 12, wherein the shape deviation is a deviation relative to a plate which is plane-parallel and parallel to the windshield, and the shape deviation is provided by at least one of: (i) a curvature of the rectifying pane which is essentially complementary to the curvature of the windshield; (ii) a non-plane-parallel or wedge-shaped design of the rectifying pane; and (iii) positioning the rectifying pane at an angle to the windshield.

14. The method as recited in claim 12, wherein the rectifying pane has an index of refraction which differs from an index of refraction of the windshield.

15. The method as recited in claim 12, wherein the rectifying pane is configured as a plane-parallel plate and is inclined relative to the windshield in a plane in which the optical axis lies.

16. The method as recited in claim 15, wherein the windshield is inclined at a positive acute angle to the optical axis, and the rectifying pane is inclined at a positive acute angle to the windshield.

17. The method as recited in claim 15, wherein the transparent rectifying pane is configured to provide a compression of the image of the recording area in a direction in which the windshield is inclined relative to the optical axis, and wherein the degree of compression provided by the rectifying pane decreases in the direction in which the windshield is inclined relative to the optical axis with an increasing angle to the windshield.

18. An image correction device, comprising:
a mounting device configured to provide fastening on a windshield in the interior of a motor vehicle; and
a transparent rectifying pane configured to be fastened on the mounting device, wherein the transparent rectifying pane is positioned in the interior of the motor vehicle by the mounting device, and wherein the transparent rectifying pane has a shape deviation relative to the windshield.

19. The image correction device as recited in claim 18, wherein the transparent rectifying pane has one of: (i) an index of refraction which differs from an index of refraction of the windshield, or (ii) a spatial distribution of the index of refraction which differs from a spatial distribution of the index of refraction of the windshield.

20. The image correction device as recited in claim 19, wherein the rectifying pane is configured as a plane-parallel plate.

21. The image correction device as recited in claim 19, wherein the windshield is inclined at a positive acute angle to a longitudinal axis of the motor vehicle, and wherein the rectifying pane is inclined at a positive acute angle to the windshield.

22. An image recording system, comprising:
an image correction device having: a mounting device configured to provide fastening on a windshield in the interior of a motor vehicle; and a transparent rectifying pane configured to be fastened on the mounting device, wherein the transparent rectifying pane is positioned in the interior of the motor vehicle by the mounting device, and wherein the transparent rectifying pane has a shape deviation relative to the windshield; and
a camera device located in the interior of the motor vehicle, wherein the image correction device is positioned between the front of the camera device and the windshield along an optical axis of the camera device oriented toward a recording area outside the motor vehicle.
